(19) United States
(12) Patent Application Publication
(10) Pub. No.: US 2012/0038221 A1
(43) Pub. Date: Feb. 16, 2012

(54) ELECTRONIC CORRECTION UNIT

(76) Inventors: Arni Bergmann Petursson, Akureyri (IS); Jon Mar Halldorsson, Kopavogur (IS)

(21) Appl. No.: 13/201,590

(22) PCT Filed: Feb. 15, 2010
(86) PCT No.: PCT/IS10/00003

§ 371 Date: Oct. 26, 2011

(30) Foreign Application Priority Data
Feb. 13, 2009 (IS) 8796
Sep. 25, 2009 (IS) 8849

(51) Int. Cl. H02J 3/01

(52) U.S. Cl. 307/105

(57) ABSTRACT

The present invention relates to a device for power factor correction and electrical wide band filtering in electrical systems for reducing considerably voltages of frequencies higher than 110 Hz on power systems rated for 10 Hz to 60 Hz and to improve power factor by injecting reactive power into the system. The device of the present invention provides a combination of inductors and capacitors which effectively corrects the power factor and filters out voltages of high frequencies.

### FIELD OF THE INVENTION

The present invention relates to a device for power factor correction and electrical wide band filtering in electrical systems.

### BACKGROUND OF THE INVENTION

Filtering out undesired harmonic frequencies and reducing high frequency voltages from the current in power systems is advantageous in order to reduce damage or improper operation of electrical equipment connected to the power system. In closed electrical systems, such as on board fishing ships, such disturbances cause increased use of oil to produce the desired amount of energy, which is followed by heat generation in all the electricity system and wear on the system it self and the electrical equipment connected to the system.

U.S. Pat. No. 3,555,291 discloses a harmonic filter for an AC power system, designed for converter installations, having of a plurality of conventional LC shunt filters tuned to the expected harmonic frequencies. U.S. Pat. No. 3,555,291 uses damping to diminish the effects of parallel resonance and this system can also contain static capacitors for power factor correction. This system further comprises an additional filter, being a LC filter with a resistor connected in parallel with the inductance, which is tuned to provide damping at the harmonic frequency at which parallel resonance may occur. The resistor in this setup provides damping and therefore reducing the amplitude of oscillations under parallel resonant conditions.

### SUMMARY OF THE INVENTION

It is an object of the present invention to provide an improved device and method.

The object of the invention is achieved by the features of the claims and/or the following aspects of the present invention.

In particular, it is a preferred advantage of the present invention to provide a device for reducing considerably voltages and current of frequencies higher than 110 Hz on power systems rated for 10 Hz to 60 Hz and/or to improve power factor.

In particular, the electric correction unit and the method for reducing voltages and current of undesired frequencies of the present invention improves power factor by injecting reactive power into the system. A preferred embodiment of the device (in the following also labelled as electric correction unit) of the present invention provides a combination of inductors and capacitors in such a manner that a low pass filter is connected in series with a band-stop filter unit, which also acts as power factor correction unit, an the electric correction unit is connected to the system in parallel to the load.

The electric correction unit reduces voltages of undesired frequencies carried on the carrier frequency and thereby reduces heat-formation in the power system. As the band-stop filter unit is serially connected behind/after the low pass filter, the high frequencies are drawn into the low pass filter and eliminated there, whereas the distortion in the lower frequency range is corrected or eliminated in the band-stop filter unit. The band-stop filter unit draws fifth harmonic frequencies towards it and the voltages of undesired frequencies are carried on the fifth harmonic. As the band-stop filter unit is serially connected behind/after the low pass filter, the high frequencies are pulled into the low pass filter and eliminated there. The band-stop filter unit of the present invention is designed such that the capacitors are connected in a delta connection and inductor units (reactors) are connected in a star (Y or Wye) connection.

The band-stop filter unit is preferably loaded with the tuned frequency (frequencies) that shall be reduced, e.g. 250 Hz on a system rated 50 Hz. In this case the 250 Hz current is a carrier for voltages of higher frequencies, e.g., from 10³ Hz to 10¹⁰ Hz that are preferably considerably reduced in the low pass filter.

In a first aspect of the present invention an electric correction unit is provided for an electrical system. The electric correction unit comprises a low pass filter and a band-stop filter unit, where the band-stop filter unit is serially connected to the low pass filter and the electric correction unit is connected in parallel with load on the system.

In a second aspect of the present invention a method is provided for reducing voltages of undesired frequencies and improving power factor in power systems, the method comprising placing an electric correction unit adjacent to a major load in the system, the electric correction unit comprises a low pass filter and a band-stop filter unit. The band-stop filter unit is serially connected to the low pass filter and the unit is connected in parallel with load on the system.

The operating frequency of combined filter is preferably 110 Hz to 10¹⁰ Hz, preferably from 110 to 10⁹ Hz, or from 250 to 10⁸ Hz, or from 110 to 10⁸ Hz, or from 250 to 10⁹ Hz, or from 110 to 10⁷ Hz, where the operating frequency of the reactive power unit preferably ranges from 10 Hz to 400 Hz, depending on the rated frequency of the power system.

In an embodiment of the present invention the electric correction unit, which may also acts as band-stop filter unit is detuned closed to the frequencies that shall be eliminated, e.g. close to 250 Hz in case of 5^{th} harmonic (for a system rated 50 Hz).

In an embodiment of the present invention the operating frequency of the low pass filter assembly is preferably from 10³ to 10¹° Hz, preferably from 10⁴ to 10⁹ Hz, or from 10⁴ to 10⁸ Hz, or from 10³ to 10⁸ Hz, or from 10⁴ to 10⁹ Hz, or from 10³ to 10⁷ Hz.

In an embodiment of the present invention the operating frequency of the band-stop filter unit is preferably from Hz from 110 to 910 Hz, or from 110 to 810 Hz, or from 110 to 740, or from 310 to 710 Hz, from 410 to 610 Hz. or from 110 to 310 Hz.

In a specific embodiment of the present invention the operating frequency of the one or more band-stop filter unit is that it passes through frequencies in the range from 180 to 290 Hz, such as 180 to 240 Hz for a system with operating frequency of 50 Hz and preferably 210 Hz or 230 to 290 Hz for a system with operating frequency of 60 Hz and preferably 260 Hz.

In a specific embodiment of the present invention the electric correction unit is operating in a 10 to 800 Hz power system, such as in a 10 to 400 Hz power system, or 10 to 200 Hz power system, or 10 to 60 Hz power system, such as 50 Hz power system or a 60 Hz power system.

In an embodiment of the present invention the rated voltage can range from 100 V to 750 kV and the rated current can range from 1 A to 100 kA.

In a specific embodiment of the present invention the low pass filter used in the assembly of the electric correction unit is a 3-line EMC filter of the series B84143B* S020 . . . . S024 obtainable from EPCOS AG.

In an embodiment of the present invention the electric correction unit relates to a device for conditioning the power system. In the present context the term “conditioning” refers to filtering out voltages of undesired frequencies, improving the power factor or correcting the power factor in the system.

In an embodiment of the present invention the electric correction unit is installed in a closed electrical system such as a fishing vessel. Devices such as winches for pulling fishing nets use an enormous amount of electricity and therefore increase the use of oil, which is used for generating electricity for the vessel. When winces and other electricity demanding devices are in use, disturbances in the form of low and high frequency voltages are being generated in the system. The electric correction unit is installed close to an electricity demanding device, such as a winch, in order to prevent distribution of reducing voltages and current of undesired frequencies throughout the system.

In the present context the term “low pass filter” or “low pass filter unit” refers to a filter that passes low-frequency signals but attenuates, or reduces the amplitude of signals with frequencies within the bandwidth of the filter (but attenuates, or reduces the amplitude of signals with frequencies) being higher than the cut-off frequency for said filter. The actual amount of attenuation for each frequency varies from filter to filter. Furthermore, a low-pass filter assembly refers to a plurality of low-pass filters, which are identical, i.e. having the same bandwidth and same lower and upper cut-off frequencies.

In the present context the term “band-stop filter unit” refers to an assembly of reactors (inductor units) and capacitors in a three-phase system (see FIG. 3), where the capacitors are connected in a delta connection and inductor units (reactors) are connected in a star (Y or Wye) connection. The band-stop filter unit attenuates, or reduces the amplitude of signals with frequencies within the operating frequency of the filter.

### DESCRIPTION OF THE DRAWINGS

The present invention will now be disclosed in reference to the drawings illustrating the specific embodiments of the invention. The specific embodiments disclosed herein should not be limiting to the invention as described in the claims and the description.

FIG. 1 is a schematic diagram of a power system according to an embodiment of the present invention where the electrical correction unit is connected in parallel with load on the system.

FIG. 2 is a schematic drawing of a prior art low pass filter used in the device of the present invention.

FIG. 3 is a schematic drawing of band-stop filter unit according to one embodiment the present invention.

FIG. 4 is a schematic drawing of the electrical correction unit of the present invention

FIG. 5 shows the current load, under variable load condition, with and without the correction unit.

FIG. 6 shows actual power, under variable load condition, with and without the correction unit.

FIG. 7 shows the voltage, under variable load condition, with and without the correction unit.

FIG. 8 shows current disturbance in percentage, under variable load condition, with and without the correction unit.

FIG. 9 shows voltage disturbance in percentage, under variable load condition, with and without the correction unit.

FIG. 10 shows current, power, and frequency disturbance, under normal load condition, with and without the correction unit.

FIG. 11 shows kvar, kVA, and the percentage of disturbance of kVA and frequency, under normal load condition, with and without the correction unit.

FIG. 12 shows percentage of disturbance of, under normal load condition, with and without correction unit.

FIG. 13 shows percentage of disturbance of, under normal load condition, with and without correction unit.

FIG. 14 shows system frequency, and WW, under normal load condition, with and without correction unit.

### DETAILED DESCRIPTION OF PREFERRED EMBODIMENTS

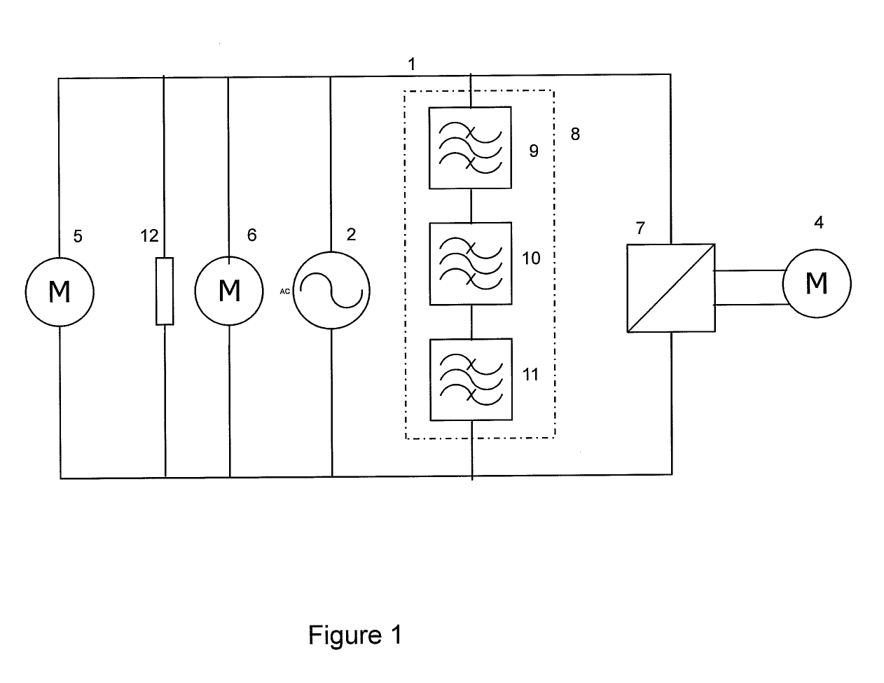

FIG. 1 shows a schematic diagram of a power system 1 in a ship having a generator 2, which generates voltages at a 50 Hz or 60 Hz frequency for winches 4, and other devices 5, 6, and 12 which depend on electricity. The system shown in FIG. 1 also comprises an AC/DC converter 7. The electrical correction unit 8 comprises a low pass filter assembly 9 and a band-stop filter unit 10. The low pass filter 9 is connected in parallel to the load as shown in FIG. 1. The band-stop filter unit 10 that also acts as power factor correction unit, is connected in series with the low pass filter 9.

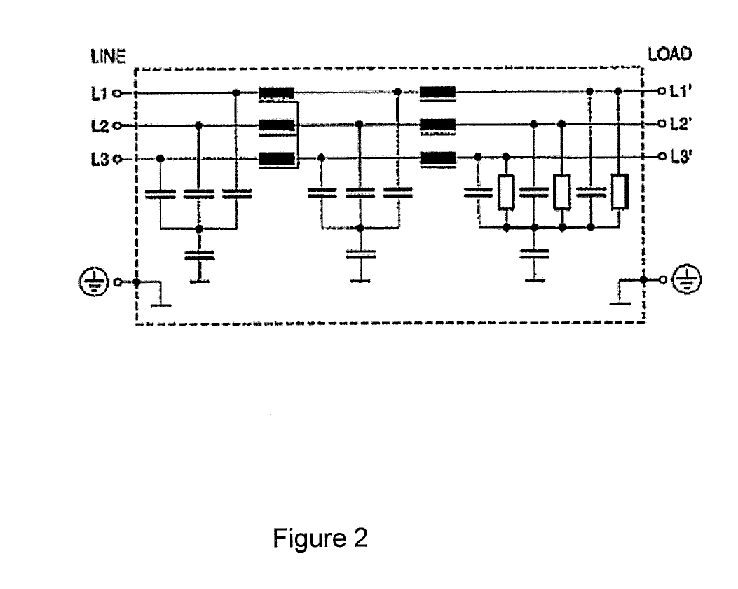

FIG. 2 is a schematic drawing of one of many suitable commercially of the shelf available high frequency EMC filter units. A suitable EMC filter unit from EPCOS© was select for the particular system setup and test will be elaborated on in this section. Other test systems with different configuration have also been tested.

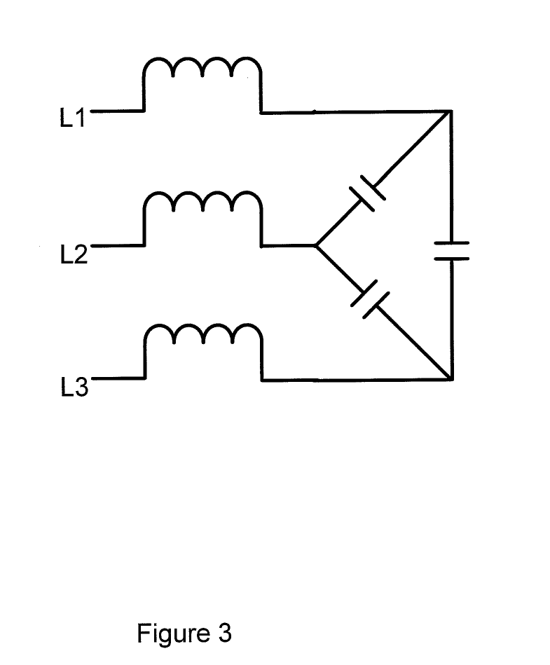

FIG. 3 is a schematic drawing of band-stop filter unit according to an embodiment of the present invention with a capacitor connected behind each inductor unit. The band-stop filter unit is designed with the tuned frequency (frequencies) that shall be reduced, e.g. 250 Hz on a system rated 50 Hz. In this case the 250 Hz is the carrier frequency for voltages of higher frequencies, from 10³ Hz to 10¹⁰ Hz that are considerably reduced in the low pass filter. As can be seen in FIG. 3 the capacitors are connected in a delta connection and inductor units (reactors) are connected in a star connection. The calculation for the size of the reactor units depends on the frequency and the voltage of the system.

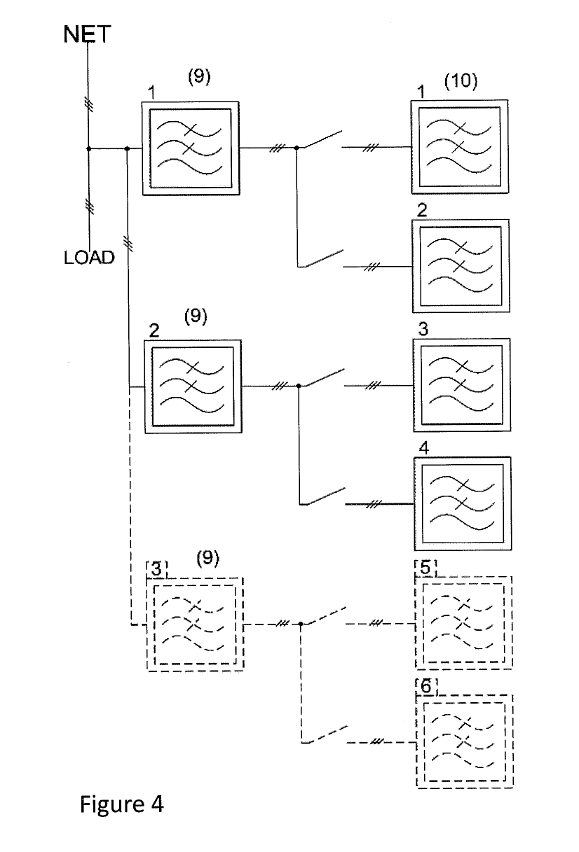

FIG. 4 is a schematic drawing of an electrical correction unit according to a preferred embodiment having three low pass filter units (9(1), 9(2), 9(3) and six band-stop filter units (10(1)-10(6). The third set of low pass filter unit 9(3) and band-stop filter units (10(5)-10(6) are shown as broken lines as an alternative embodiment. Each low pass filter unit and band-stop filter unit are connected to all lines in the three-phase electrical system (L1-L3) as shown in FIGS. 2 and 3. Under different conditions where based on the load on the system one or more low pass filter units 9 are switched on as well as two band-stop filter units 10. A computer is connected to all the units and switches on the additional band-stop filter units when the load on the system increases.

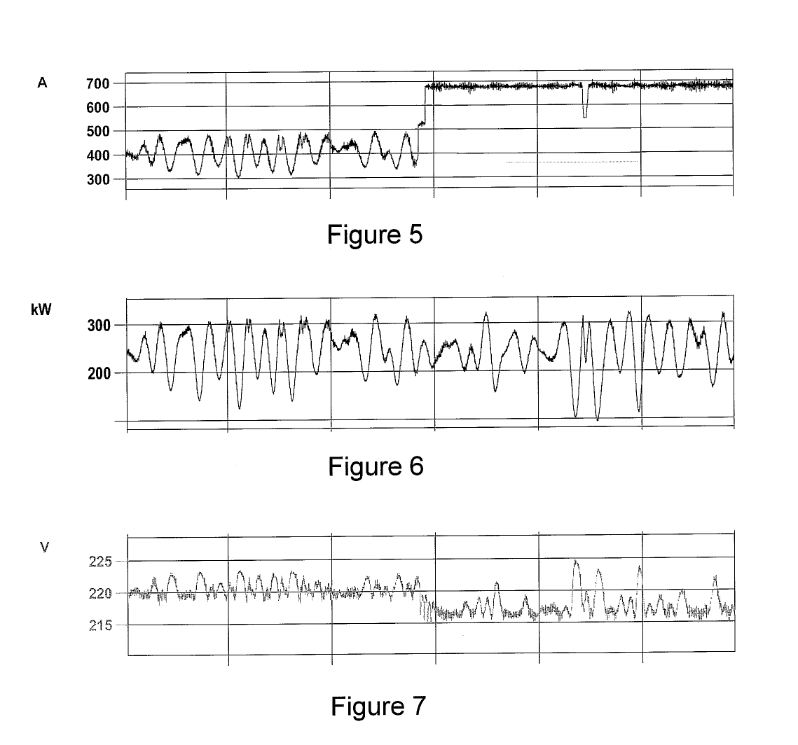

In the following examples, variable high load situations will now be discussed with reference to FIGS. 5-9. Generally, when the winches haul in the fishing gear, the generator load varies considerably. One of the reasons for this is the vertical motion of the ship, caused by rough seas. The performance of the electrical correction unit was tested in these conditions, as is shown in the following text. The first half of each plot in FIGS. 5-9 demonstrates the electrical system operation when the electrical correction unit is switched ON and the second half of the plot with the correction unit switched OFF.

The system phase current is shown in FIG. 5 and the power load in FIG. 6. In the first half, when the correction unit is ON, it can be seen that the ampere load fluctuates at about 400 A and in accordance with the power load. In the second half, the current rises to about 700 A and is not in accordance with the power load. This stems from the fact that the generator is hyper magnetized and the voltage regulator is not functioning properly because of high frequency interference, as shown in FIG. 7.

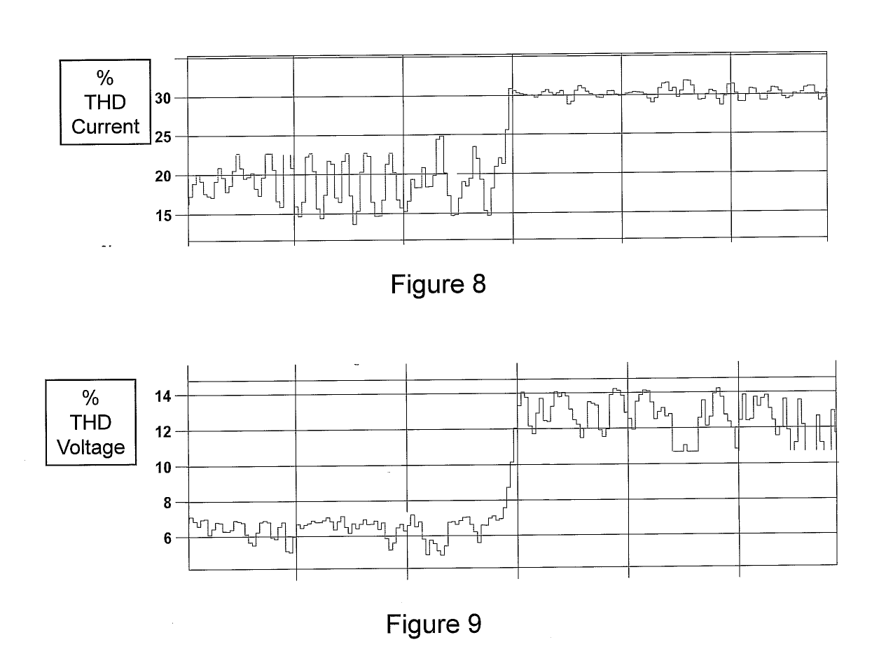

FIG. 8 shows the Total Harmonic Distortion (THD) of the current sinusoidal wave form. When the correction unit is switched ON, the THD level of the current wave form ranges between 15-25% and varies in accordance with the ampere load of FIG. 5. Once the correction unit is switched OFF, the THD level of the wave form rises to about 30% and fluctuates slightly, because of limited fluctuation in the ampere load.

FIG. 9 shows the THD of the voltage sinusoidal wave form. Again, when the correction unit is switched ON, the THD level of the curve is relatively small, i.e. around 6-7%, and varies in accordance with the voltage of FIG. 7. When the correction unit is switched OFF the THD of the voltage wave form rises to approximately 13%.

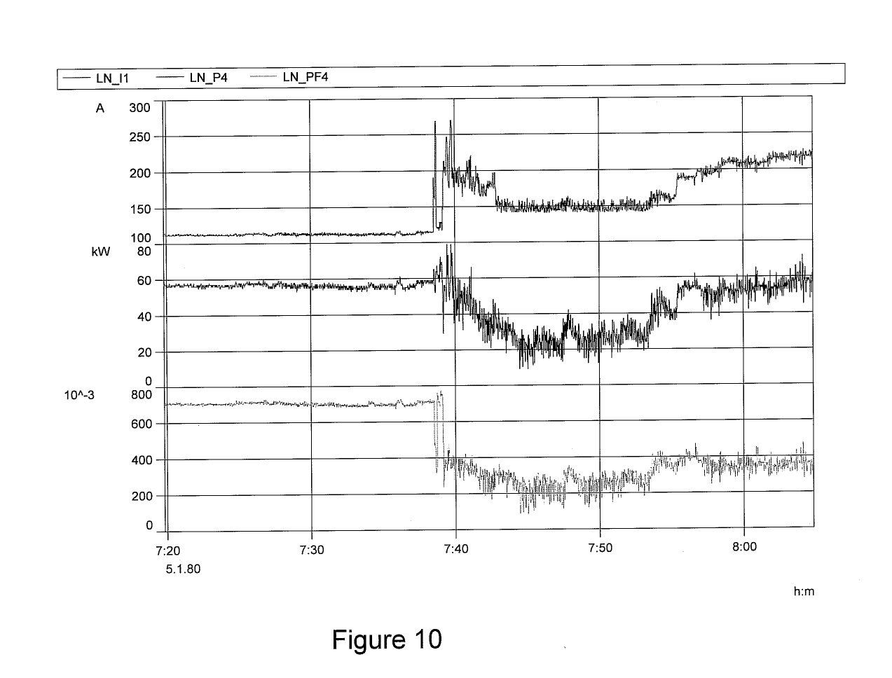

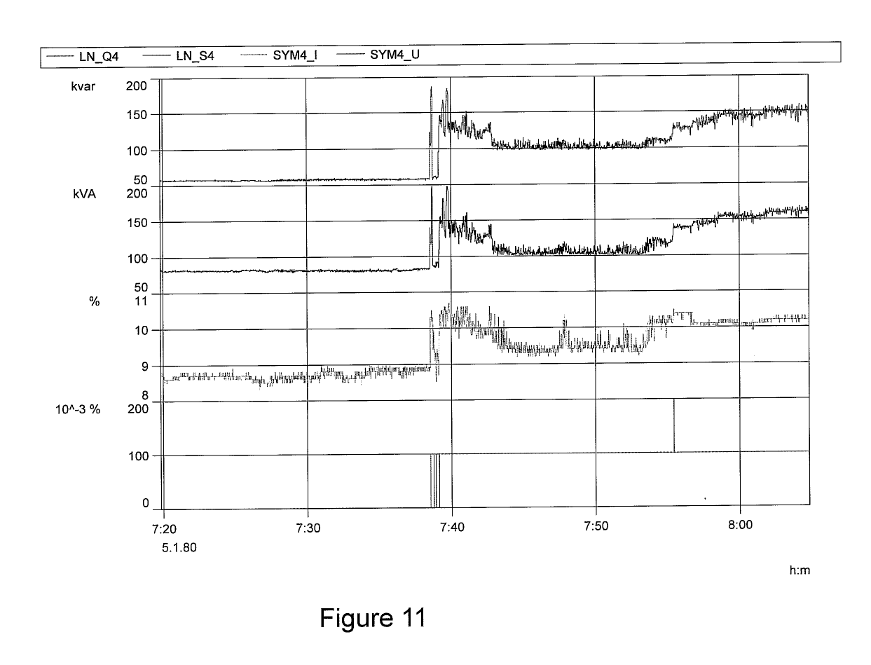

Similarly, FIGS. 10-14 show the system of the same fishing vessel under low load with and without the electrical correction unit switched ON. In all the figures the horizontal axis shows time in 10 minute intervals. In FIG. 10 the vertical axis shows the current [A], the active power [KW] and power factor. During the first 20 minutes the electrical correction unit is ON. The current is quite stable around 110 A as is the power load of 57 KW. The power factor is also fairly good, around 0.75. Then, when the electrical correction unit is switched OFF at 7:38, the system enters an unbalanced state with a lot of interference and the power factor goes down to 0.3, which is far too low. FIG. 11 shows reactive power, apparent power, phase current symmetry and phase voltage symmetry. The plot shows how the correction unit reduces reactive power and stabilizes the system.

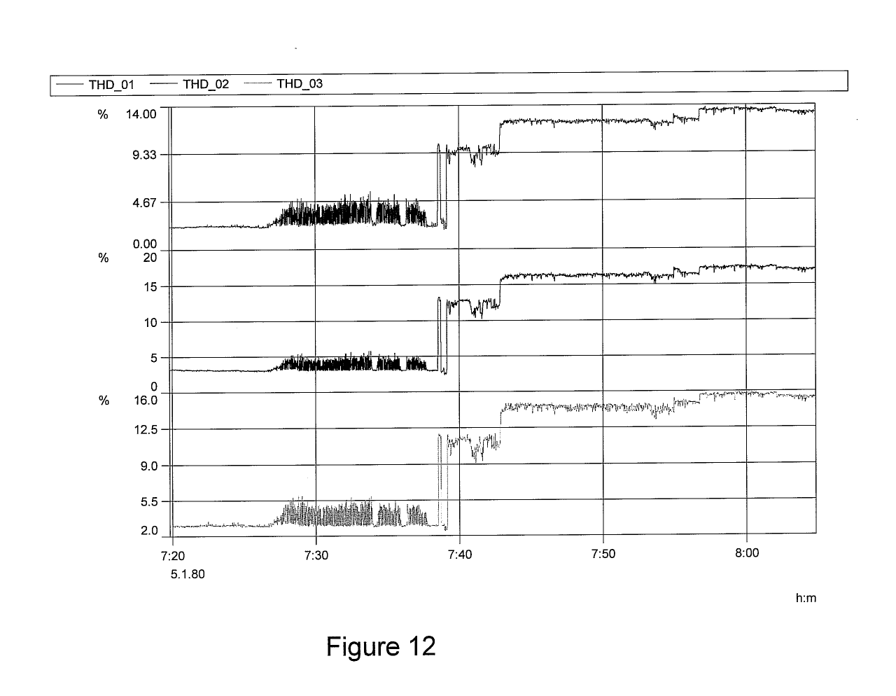

FIG. 12 shows the THD percentage level of the phase currents during the same period. With the correction unit ON, the THD in each phase current is approximately 5%, while it rises to 14-16% with the correction unit switched OFF.

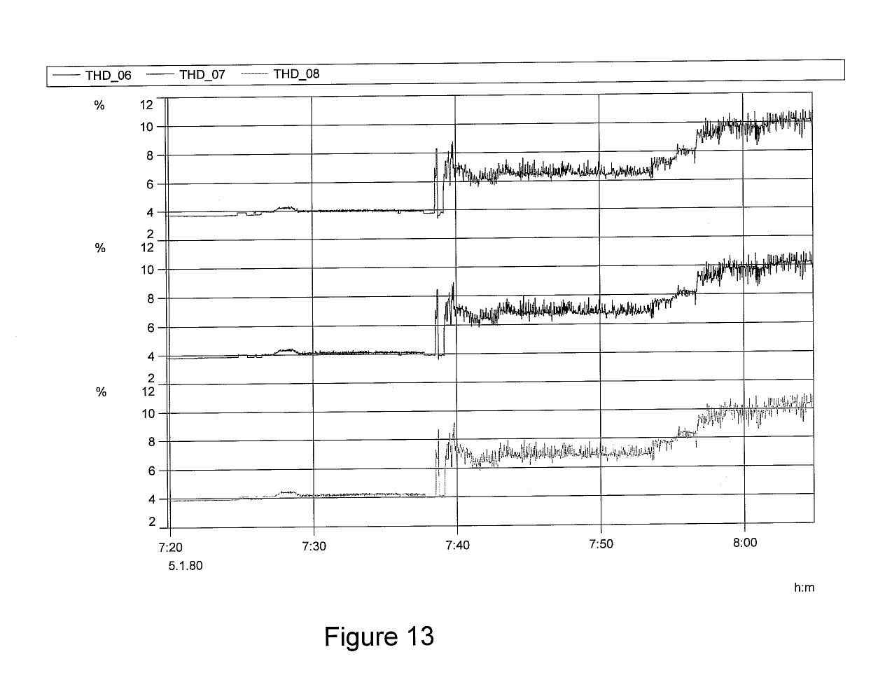

FIG. 13 similarly shows the THD percentage level of the phase voltage. With the correction unit on the THD level is approximately 4% and without the correction unit it is approximately 10%.

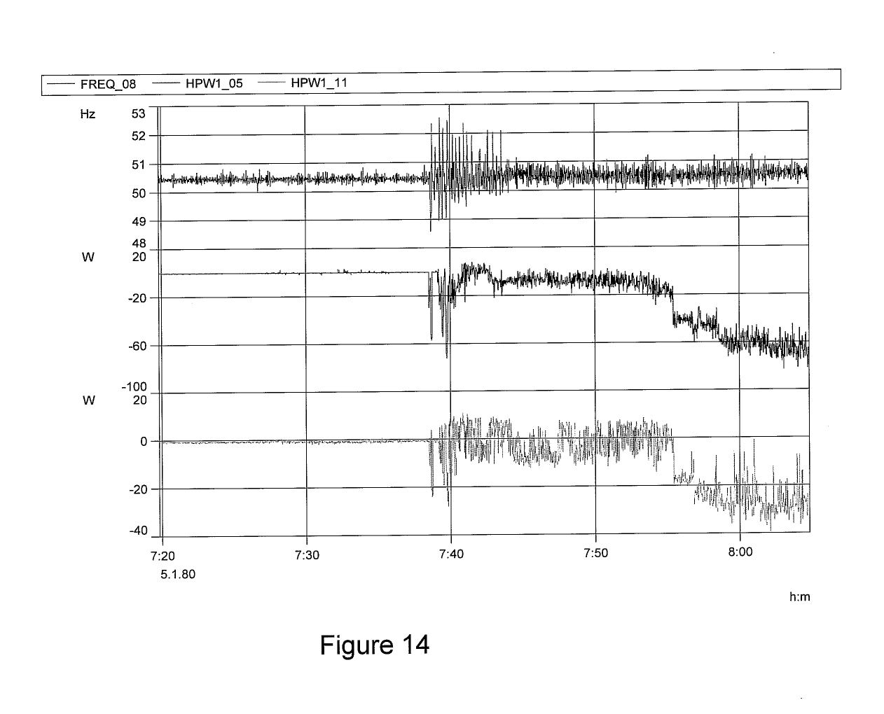

The electrical system frequency is the first plot of FIG. 14. The frequency is clearly very stable at 50.5 Hz with the correction unit switched ON. Once the correction unit is switched OFF the frequency starts fluctuating. The two other plots show the active power in 5^{th} and the 11^{th} Harmonic Frequency. Attention should be drawn to the fact that when the correction unit is switched ON, almost no power is in harmonic frequencies, but when the unit is switched OFF; power is clearly detected in these harmonic frequencies.

High frequency distortion in electrical systems is largely caused by AC/DC converters and many other devices. The most common solution to eliminate these high frequency distortions is to filter them out and convert them to heat. The uniqueness of the design of the electrical correction unit is not to convert these distortions to heat but to remove them through a process of elimination.

One of the main advantages of the electrical correction unit is that it significantly corrects the Power Factor (PF) of the electrical system. By correcting the PF, the phase lag between voltage and current is eliminated. This will be demonstrated in Table 1, here below, and it can also be seen in FIG. 10. The table reflects the same power reading, when the correction unit is switched OFF, but the current rises significantly from 270 A to 640 A and the PF drops from about 0.87 to 0.35.

TABLE 1

| | Electrical | Electrical |
|---|---|---|
| | Correction Unit | Correction Unit |
| | On | Off |
| Generator | 35-45° C. | 60-80° C. |
| Temperature | | |
| Real Power | 160 KW | 160 KW |
| Current | 270 A | 640 A |
| Power Factor | 0.85-0.9 | 0.3-0.4 |
| Reactive Power | 90 KVAr | 380 KVAr |
| Apparent Power | 190 KVA | 410 KVA |

By correcting the PF, eliminating high frequency and harmonic distortions, the electrical correction unit significantly reduces the generator load and thus saves a lot of energy. This can be seen in Table 1, when the correction unit reduces the apparent power by 220 KVA (54%) and the generator temperature drops by 30° C. (57%).

In an example of the function and the generation of the device of the present invention, for the disclosed electric correction unit is in an electrical system distant from the main power grid. The example shows the calculation of component values of a specific system. This is a 400V, 50 Hz system with an output of 217.5 A.

Instead of the electrical shocks of a local system distant from the main grid forcing the main system into some imbalanced state, the distortion of the local system is injected into the local system and the main frequency of the system becomes the carrier frequency of the distortion. Experiments of the inventors have shown that due to high impedance on the grid, load on the system, distant from the local load can cause similar effects as in a smaller system such as in a ship. This of course can be calculated for each system as shown here below by a calculation of the components values used in the band-stop filter unit of the present invention. The unit both corrects the phase shift between the voltage potential in each phase of the system and the current. This indeed is revolutionary for the current practice.

Requirements for the band-stop filter unit:

Connection of capacitor in a delta connection and inductor unit (reactor) in a star connection.

| Size of capacitor | 996 micro F | Frequency | 50 Hz |
|---|---|---|---|
| Size of reactor | 0.136 mH | Voltage | 400 |

On 50 Hz: Xc=3,198 ohm (in a delta-connection)
Xl=0.043 ohm (in a star-connection)

Capacitor recalculated for star-connection—By using 3 capacitors (MKK400-d-50-21 (3×332 micro F) in each system (smt.4 system)

| | | |
|---|---|---|
| On 50 Hz: | Xc = 1.066 ohm | |
| | Xl = 0.043 ohm | |
| | Ztot = 1.023 ohm | 3-phase power: 150.5 kVAr |
| | | Phase current: 217.5 A |

Size of capacitor 2988 micro F
Size of reactor 0.136 mH

While the invention has been illustrated and described in detail in the drawings and foregoing description, such illustration and description are to be considered illustrative or exemplary and non-restrictive; the invention is thus not limited to the disclosed embodiments. Variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. Any reference signs in the claims should not be considered as limiting the scope.

1. Electric correction unit for an electrical load system, the unit comprising:
at least one a low pass filter,
at least a band-stop filter unit, and
wherein the low pass filter unit is serially connected with the low pass filter (9), and
wherein the electric correction unit the unit is connected in parallel with the load.

2. The electric correction unit according to claim 1, wherein the operating frequency of the low pass filter is from 10³ to 10¹⁰ Hz, such as (preferably) from 10⁴ to 10⁹ Hz, or from 10⁴ to 10⁸ Hz, or from 10³ to 10⁸ Hz, or from 10⁴ to 10⁹ Hz, or from 10³ to 10⁷ Hz.

3. The electric correction unit according to claim 1, wherein the operating frequency of the band-stop filter unit (11) is from 110 to 910 Hz, such as from 210 to 910 Hz, from 110 to 810 Hz, or from 110 to 740, or from 310 to 710 Hz, from 410 to 610 Hz. or from 110 to 310 Hz.

4. The electric correction unit according to claim 3, wherein the operating frequency of the band-stop filter unit is range from 180 to 310 Hz, such as from 180 to 260 or 210 to 310 Hz.

5. The electric correction unit according to claim 1, wherein in the band-stop filter unit capacitor unit is connected in a delta connection and inductor unit (reactor) is connected in a star connection.

6. The electric correction unit according to claim 1, wherein the unit is operating in a 20 to 400 Hz power system, such as 50 to 200 Hz power system or 60 to 100 Hz power system.

7. The electric correction unit according to claim 1, wherein the unit is adapted to operate in a 50 Hz and/or a 60 Hz power system.

8. The electric correction unit according to claim 1, wherein the low pass filter comprises a plurality of low pass filter are adapted to be individually connectable to the load.

9. The electric correction unit according to claim 1, wherein the one or more band-stop filter units are adapted to be individually connectable to the load.

10. The electric correction unit according to claim 1, wherein the load is an AC/DC converter injecting 250 Hz signal into the power system.

11. A method for reducing voltages of undesired frequencies and improving power factor in power systems, the method comprises
placing a electric correction unit, in particular according to claim 1, in parallel to a major load on the system, the electric correction unit comprises:
low pass filter, and
band-stop filter unit,
characterised in that the band-stop filter unit, is serially connected to the low pass filter, and in that the electric correction unit is connected in parallel with load on the system.
